(19) United States
(12) Patent Application Publication
(10) Pub. No.: US 2023/0113483 A1
(43) Pub. Date: Apr. 13, 2023

(54) AERIAL VEHICLE WITH MULTI AXIS ENGINE

(71) Applicant: Stephen Favis, Sacramento, CA (US)

(72) Inventor: Stephen Favis, Sacramento, CA (US)

(21) Appl. No.: 18/076,643

(22) Filed: Dec. 7, 2022

Related U.S. Application Data
(60) Provisional application No. 63/253,264, filed on Oct. 7, 2021.

(51) Int. Cl. B64C 39/02; B64D 7/04; B64D 1/04; B64U 50/10; B64U 20/87; B64U 20/10; G05D 1/08

(52) U.S. Cl. CPC B64C 39/024; B64D 7/04; B64D 1/04; B64U 50/10; B64U 20/87; B64U 20/10; G05D 1/0808; B64U 2101/18

(57) ABSTRACT

An aerial vehicle platform, which may be unmanned, includes an engine rotatable along multiple axes to provide various modes of flight and movement. The platform may be scaled for different purposes. The purposes may range from defense, to reconnaissance, and to civilian or commercial applications. Other applications may also benefit from the embodiments disclosed. Embodiments may include a gimbal hub to control the orientation of the engine along different axes.

### CROSS-REFERENCE TO RELATED APPLICATION

This application claims benefit under 35 U.S.C. § 119(e) of U.S. Provisional Application having Ser. No. 63/253,264 filed Oct. 7, 2021, which is hereby incorporated by reference herein in its entirety.

### FIELD

The subject disclosure relates to vehicles, and more particularly to an aerial vehicle with a multi axis engine.

### BACKGROUND

Current unmanned aerial vehicles (UAV), sometimes referred to as drones, are generally equipped with in line engines or quadrotors that generally spin parallel to a ground surface.

### SUMMARY

In one aspect of the disclosure, an aerial vehicle platform is provided. The platform includes a body including one or more wings. A control system is coupled to the body. The control system includes a wireless receiver, a computer processing unit, and a bus line. The platform also includes a swivel mount and an engine coupled to the body by the swivel mount and connected to the bus line. The engine is movable in multiple axes under a control of the computer processing unit and in response to a command received by the computer processing unit through the wireless receiver, and re-transmitted through the bus line to the swivel mount.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

FIG. 1 is a top perspective view of an unmanned aerial vehicle (UAV) with a multi-axis engine assembly in accordance with an embodiment of the subject technology.

FIG. 2 is a top perspective view of the UAV of FIG. 1 with the engine assembly rotated along on axis in accordance with embodiments.

FIG. 3 is a top, perspective view of the UAV of FIG. 1 with the engine assembly rotated along another axis consistent with embodiments.

FIG. 4 is a top view of the UAV of FIG. 3 with the engine assembly rotated further along the axis illustrated in FIG. 3.

FIG. 5 is an enlarged top perspective of the UAV of FIG. 1.

FIG. 6 is a top view of the UAV of FIG. 5.

FIG. 7 is a right side edge view of the UAV of FIG. 5.

FIG. 8 is a bottom view of a UAV with integrated countermeasures consistent with an embodiment.

FIG. 9 is a top perspective view of a UAV with an integrated weapons system consistent with embodiments.

FIG. 10 is a top, front perspective view of a UAV according to another embodiment.

FIG. 11 is a top, rear perspective view of the UAV of FIG. 10.

FIG. 12 is a top view of the UAV of FIG. 10.

FIG. 13 is a bottom view of the UAV of FIG. 10.

FIG. 14 is a front edge view of the UAV of FIG. 10.

FIG. 15 is a top, front perspective view of a multi-axis engine assembly consistent with embodiments.

FIG. 16 is a top, rear perspective view of the multi-axis engine assembly of FIG. 15.

FIG. 17 is a top view of the multi-axis engine assembly of FIG. 15.

FIG. 18 is a top view of the multi-axis engine assembly of FIG. 15.

FIG. 19 is a block diagram of a control system for a UAV according to an embodiment.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. Like or similar components are labeled with identical element numbers for ease of understanding.

Referring to the Figures in general, embodiments of the subject technology provide an unmanned aerial vehicle (UAV) with versatile flight capability. In an exemplary embodiment, the UAV includes a multi-axis engine that is controllably moved to re-direct the thrust propelling the UAV in flight. In some embodiments, the UAV engine control may operate in three axes that may include yaw, pitch, and roll lines of flight. In some embodiments, the engine control may operate in two axes; pitch and yaw of the engine. The aerial platform includes features which are useful in multiple roles, whether the vehicle is used for defense, reconnaissance, or civilian utility or commercial purposes. Aspects of the UAV are scalable which make it conducive to serving different roles depending on the need.

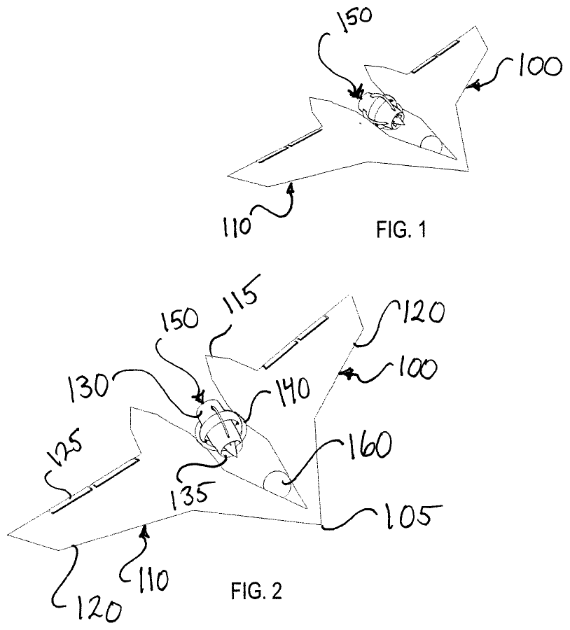

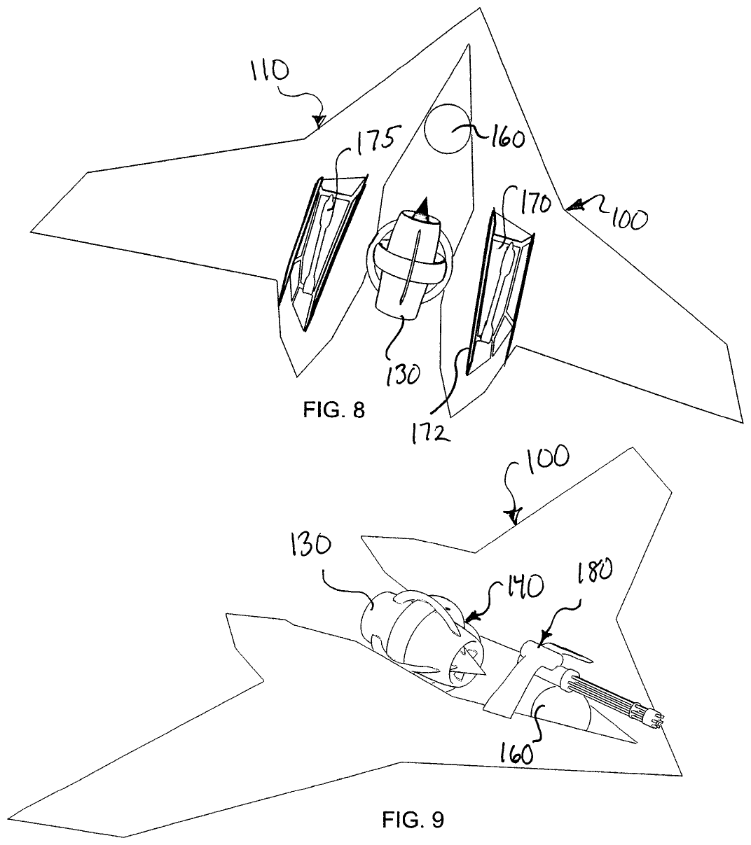

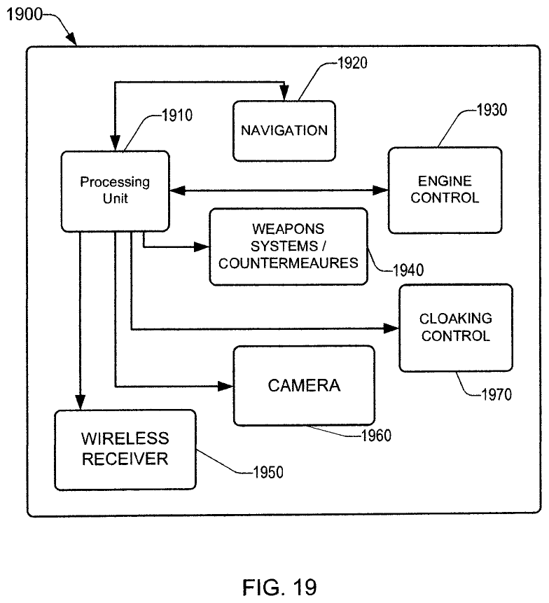

Referring now to FIGS. 1-7, a UAV 100 is shown according to an embodiment. The UAV 100 generally includes a winged body 110 (sometimes referred to in general as the “body 110”) and an engine assembly 150. The UAV 100 may be an unmanned vehicle controlled remotely by an operator or computer control system. The control system of UAV embodiments is described further below with respect to FIG. 19.

As points of reference, the embodiment shown may include a nose 105 and a tail 115 so that one understands the default direction of flight. In some embodiments, the body 110 may be a single piece body; also known as one-piece construction. In some embodiments, the body 110 includes one or more wings 120. While a winged embodiment is shown, it will be understood that some embodiments may be non-winged (for example, using a disc-shaped body, an orb, or other shape). The wings 120 may be part of a one-piece construction or may include control surfaces; for example, ailerons 125 (or elevators, flaps, etc. as is known in the field of wing control surfaces). In some embodiments, the body 110 may include an open middle section. The engine assembly 150 may be positioned within the open section between inside edges of the body 110. As may be appreciated, by splitting the body 110 so that the open area between sides is present, forces from air drag may be minimized so that applications may be available for operation at transonic or higher speeds.

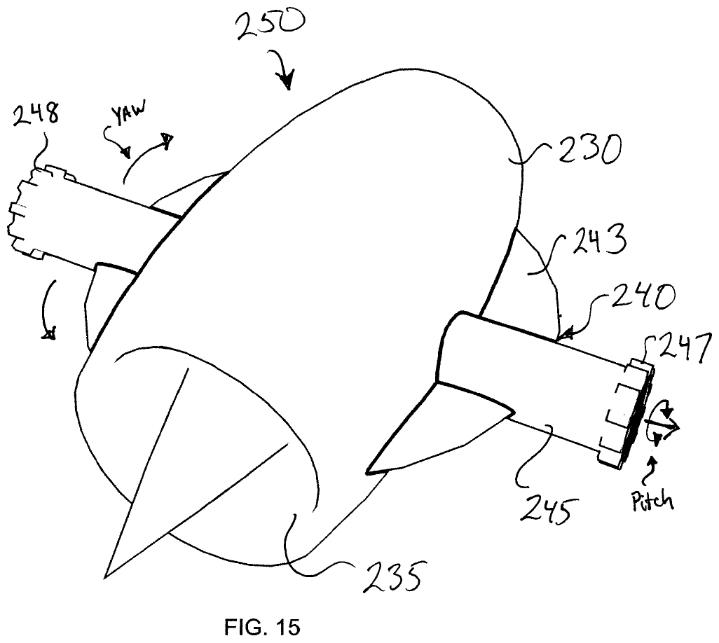

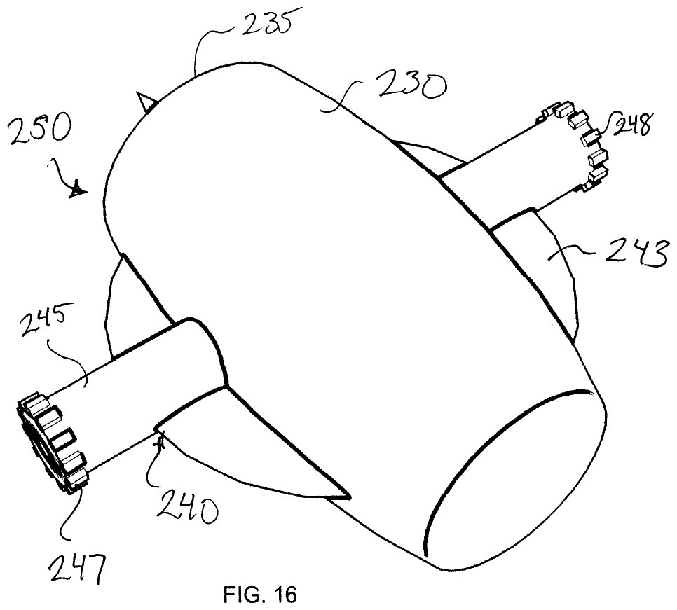

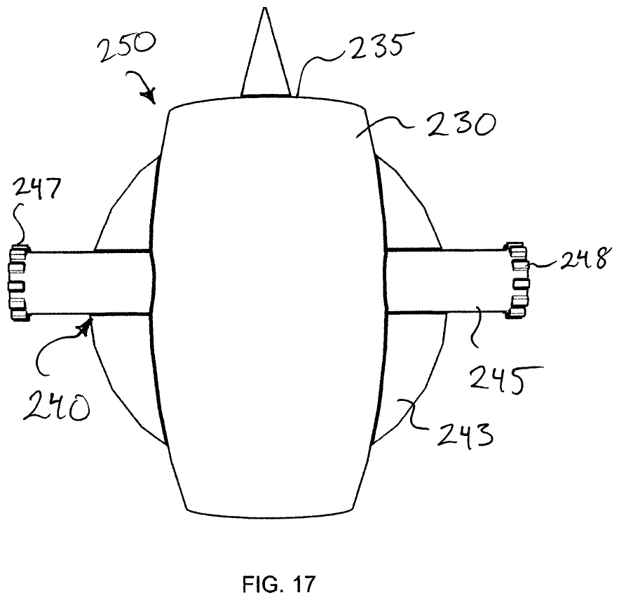

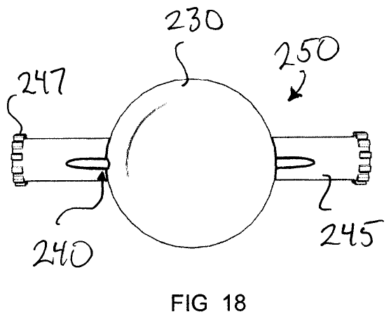

The engine assembly 150 includes an engine 130 and a swivel mount coupling the engine 130 to the body 110. The engine 130 may be a rotor type engine. As a point of reference, an intake 135 side of the engine 130 is shown pointing to the nose 105 in FIGS. 1 and 5-7 as a default orientation for forward thrust. The gimbal control hub 140 generally controls the orientation of the engine 130 so that the intake 135 points in different directions along different axes to provide multi-axis movement of the UAV 100. Details of an example gimbal control hub 140 are disclosed further below in FIGS. 15-18.

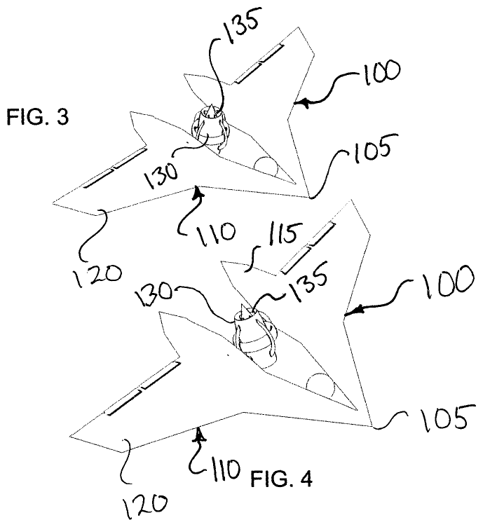

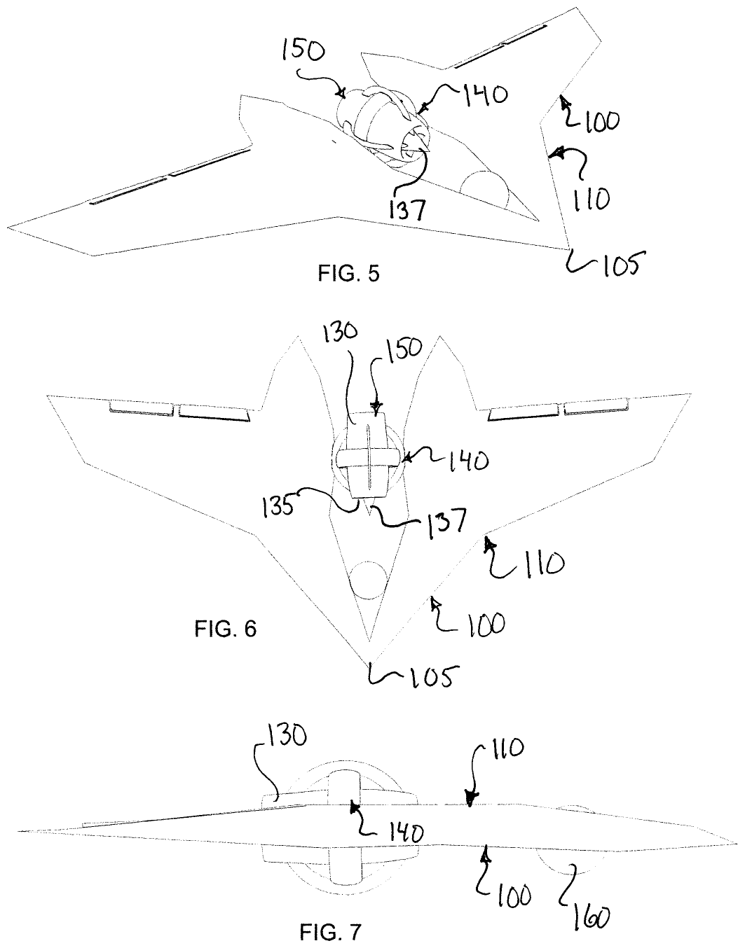

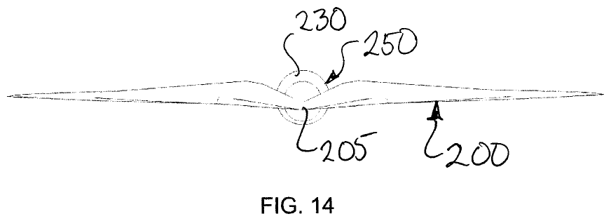

In one embodiment, the swivel mount may be a gimbal control hub 140. The gimbal control hub 140 controls the direction of thrust to be moved at takeoff, during flight, or when landing. Embodiments of the gimbal control hub 140 may control orientation of the engine 130 in pitch, yaw, and roll axes. The yaw axis is defined by moving the intake 135 in rotation on a plane toward one wing 120 or the other wing 120. For example, referring temporarily to FIGS. 5 and 6, the intake 135 may include an inlet cone 137 which may serve as a point of reference. The nose 105 and inlet cone 137 may share the same horizontal plane at default and may be colinear with each other on an axis. One may also refer temporarily to FIG. 14 which discloses another embodiment, for a front view of a UAV 200 showing the nose 205 aligned on a same longitudinal axis as an engine 230 in a default position. Referring back to FIGS. 1-7, rotation of the engine 130 in the yaw axis maintains the inlet cone 137 on the same plane as the nose 105 but deviates the longitudinal axis of the inlet cone 137 from the axis that defines the front to rear of the body 110 running through the nose 105. See FIG. 2 for an example of rotation on the yaw axis. The pitch axis is defined by rotation of the engine 130 so that the intake 135 points 360 degrees along a vertical path perpendicular to the body 110, from the nose 105 toward the tail 115. For example, the inlet cone 137, when rotated in the pitch axis no longer shares the same horizontal plane as the nose 105. For a UAV 100 flying parallel to the ground, the intake 135 may point directly to the ground or directly away from the ground, or through points in between when rotated along the pitch axis. FIG. 3 shows a representation of the intake 135 moved along the pitch axis, pointing away from the ground which would cause directly vertical descent. FIG. 4 shows a representation of the intake 135 rotated in pitch passed the midpoint from the nose 105 toward the tail 115. Control along the roll axis may be performed by maintaining the engine 130 co-linear with the nose 105 while spinning the engine 130 housing around its longitudinal axis.

As may be appreciated, the three-axis movement of engine 130 allows the UAV 100 to switch from different modes of flight including for example, a vertical takeoff and landing (VTOL) mode, a straight line mode of flight, hover mode, and evasive maneuvers mode which accentuates sharp turns and changes of direction. While movement along three different axes, (yaw, pitch and roll) were described individually, some embodiments may combine movement along two or more axes simultaneously to enhance maneuverability (which may be especially helpful during evasive maneuvers).

Referring now to FIGS. 2, 8 and 9, embodiments may include features for added versatility and utility. For example, some embodiments may include a camera 160 to record images during flight. The camera 160 may be coupled to the inside edges of the body 110 so that the camera 160 is positioned in the open area of the body 110. The camera 160 may be controlled for a 360-degree field of view below and or above the plane of the body 110. By being positioned in the open area of the body 110, the camera 160 may have a nearly omnidirectional field of view capability. In some embodiments, the camera 160 (or generally the mechanism detaining the camera), may be modular for switching out different payload features. The camera 160 may be used for airport tarmac inspection, search and rescue and other aerial photography applications. Some embodiments may include an internal payload compartment 170. A door 172 may be opened to release a payload (which may be a weapon, a countermeasure or other item). Countermeasures may include decoys, flares or other defense items. In some embodiments, the countermeasures may use kinetic ammunition that may be non-explosive (for example, air pellets). Some embodiments may include an external weapon or attack system 180 to defend the UAV 100 during an operation or for use in attacking a hostile target. While a rapid gun is shown, it will be understood that other weapons including for example, lasers may be used.

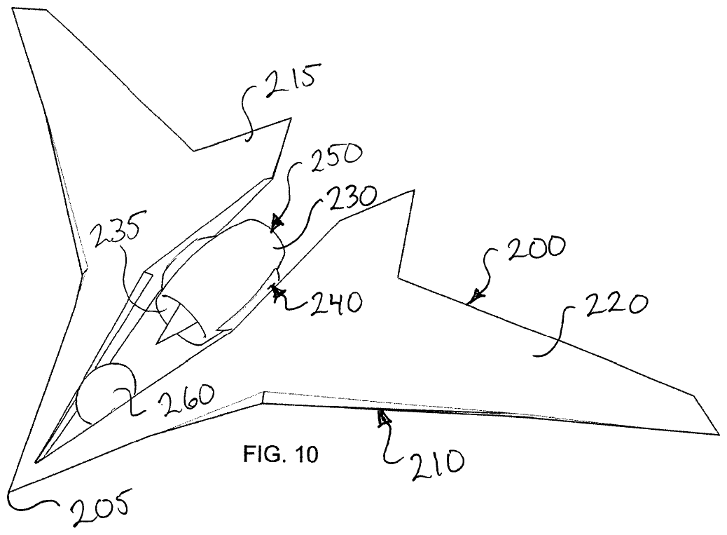

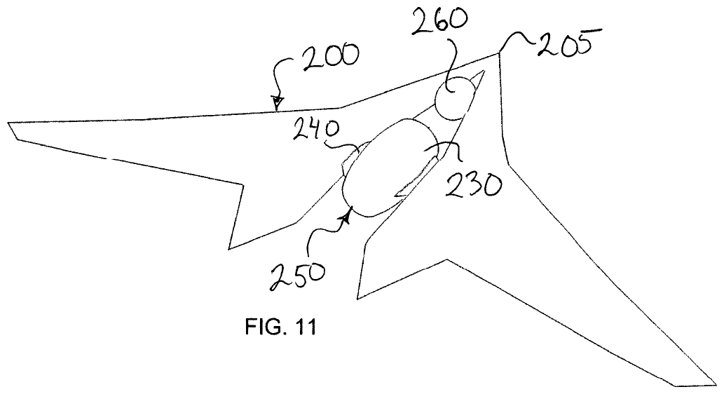

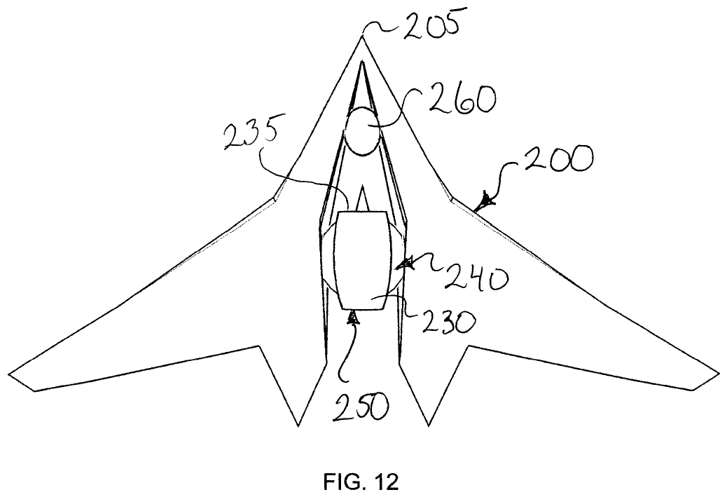

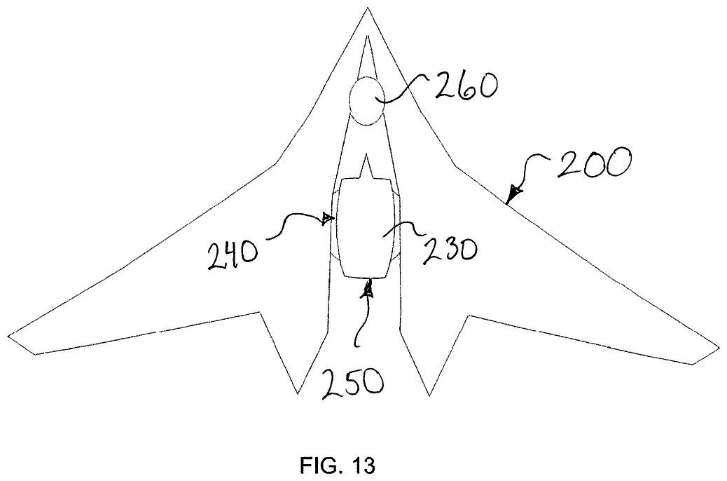

Referring now to FIGS. 10-14, a UAV 200 is shown according to an embodiment. The UAV 200 is similar to the UAV 100. Accordingly, like elements are referenced using like numbering except that the numbering is shown in the 200 series. Thus, similar features will not be described again for sake of omitting unnecessary redundancy in the disclosure. The UAV 200 shares many of the same features as the UAV 100 except that the UAV 200 uses a two-axis gimbal control hub 240 and does not show control surface features on the wings 220. The gimbal control hub 240 may be configured to rotate the engine 230 in the pitch and yaw axes which are defined similarly by the same analogous points of reference described with respect to UAV 100.

Referring now to FIGS. 15-18, details of an engine assembly 250 are shown according to an embodiment. The engine assembly 250 is shown enlarged to provide detailed features of the gimbal control hub 240. The gimbal control hub 240 may include a pitch control arm 245 that projects laterally from the engine 230 housing. Some embodiments include pitch control arms 245 on opposing sides of the engine 230. The pitch control arm 245 may include a circumferential gear 247 with teeth 248. While not shown, the circumferential gear 247 may couple with a receiving hub built into the interior of body 210 (FIGS. 10-15). The receiving hub may be connected to an electromechanical system configured to rotate the teeth 248 around the longitudinal axis of the pitch control arm 245 to control the degrees of pitch for the engine 230. In some embodiments, the pitch control arm 245 may also move within a horizontal channel within the interior of body 210. A semi-circular flange surface 243 may be coupled to the engine 230 and the pitch control arm 245. The semi-circular flange surface 243 and the pitch control arm 245 may rotate within the horizontal channel to control movement along the yaw axis. As should be understood, the electromechanical system controlling the pitch mechanism may be the same system controlling the yaw mechanism.

Referring now to FIG. 19, a control system 1900 is shown according to an embodiment. The control system 1900 may be mounted on-board the interior of UAV bodies. For purposes of security, an example position of the control system 1900 is now shown, however it will be understood that elements of the control system 1900 may be resident on a shared circuit board or may be distributed throughout the body of the UAV. Connections between elements of the control system 1900 may be performed using an electrical bus line (which may include wiring and/or electrical traces) which is represented by the arrows connecting the elements. The control system 1900 may include a processing unit 1910 that coordinates incoming and outgoing signals to control the other elements connected to the processing unit 1910. In some embodiments, the processing unit 1910 is part of a larger circuit or on-board computing device. Control of the UAV may be performed by signals received by a wireless receiver 1950 providing the control signals for flight, gimbal control, or other functions to the processing unit 1910. The incoming signals may be provided by a manual operator or a computer system sending remote commands. Flight control signals may be coordinated with a navigation control module 1920 that may store on-board maps, flight plans, and orientation of the UAV during flight maneuvers. The processing unit 1910 may provide signals to an engine control system 1930 that may be part electronic and part mechanical to control the gimbal functionality described above to rotate the engine as needed. In some embodiments, the processing unit 1910, the navigation module 1920, and the engine control system 1930 cooperate to automatically control the engine orientation and wing orientation to accomplish maneuver requests. The processing unit 1910 may also control the operation of on-board weapons and/or countermeasures 1940 (which may include in some instances, opening doors, releasing payloads, arming weapons, and monitoring ammunition levels). The processing unit 1910 may control camera systems 1960 (which may be include the cameras 160 and 260 disclosed above). Data recorded by the camera system 1960 may be processed, stored in on-board memory and/or transmitted (for example where the wireless receiver 1950 is a transceiver) to a remote computer. Some embodiments may include a cloaking system 1970 controlled by the processing unit 1910, which activates cloaking devices or materials on the surface of the UAV body. In some embodiments, cloaking may include RADAR or other signal jamming techniques.

Those of skill in the art would appreciate that various components and blocks may be arranged differently (e.g., arranged in a different order, or partitioned in a different way) all without departing from the scope of the subject technology. For example, some of the elements and functions in the control system 1900 may be off board the platform and provided by a remote computing system such as a cloud server that automatically controls multiple aerial platforms. For example, the navigation system 1920 may be in a remote computer in some embodiments.

The previous description is provided to enable any person skilled in the art to practice the various aspects described herein. The previous description provides various examples of the subject technology, and the subject technology is not limited to these examples. For example, while a fixed wing platform is shown, some embodiments may include foldable wings while the platform still enjoys the benefits of the three-axis engine. Various modifications to these aspects will be readily apparent to those skilled in the art, and the generic principles defined herein may be applied to other aspects.

Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

Terms such as “top,” “bottom,” “front,” “rear,” “above,” “below” and the like as used in this disclosure should be understood as referring to an arbitrary frame of reference, rather than to the ordinary gravitational frame of reference. Thus, a top surface, a bottom surface, a front surface, and a rear surface may extend upwardly, downwardly, diagonally, or horizontally in a gravitational frame of reference. Similarly, an item disposed above another item may be located above or below the other item along a vertical, horizontal or diagonal direction; and an item disposed below another item may be located below or above the other item along a vertical, horizontal or diagonal direction.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. An aerial vehicle platform, comprising:
a body including one or more wings;
a control system coupled to the body, the control system including:
a wireless receiver;
a computer processing unit; and
a bus line;
a swivel mount; and
an engine coupled to the body by the swivel mount, and connected to the bus line, wherein the engine is movable in multiple axes under a control of the computer processing unit and in response to a command received by the computer processing unit through the wireless receiver, and re-transmitted through the bus line to the swivel mount.

2. The aerial vehicle platform of claim 1, wherein the swivel mount is a three-axis gimbal configured to move the engine in yaw, pitch, and roll planes.

3. The aerial vehicle platform of claim 1, wherein the swivel mount is a two-axis gimbal configured to move the engine in yaw and pitch planes.

4. The aerial vehicle platform of claim 1, wherein the swivel mount is configured to move 360 degrees of range in the pitch axis.

5. The aerial vehicle platform of claim 1, further comprising an internal payload compartment in the one or more wings.

6. The aerial vehicle platform of claim 5, wherein the internal payload compartment is configured to store a weapon and includes a door configured to open and to release the weapon.

7. The aerial vehicle platform of claim 1, further comprising a weapon mounted externally on the winged body and controlled by the computer processing unit.

8. The aerial vehicle platform of claim 1, further comprising a camera mounted to the winged body and connected to the computer processing unit, wherein operation of the camera is performed by the computer processing unit.

9. The aerial vehicle platform of claim 1, wherein the platform is an unmanned type of vehicle.

10. The aerial vehicle platform of claim 1, further comprising a cloaking device controlled by the computer processing unit.

11. The aerial vehicle platform of claim 3, wherein the gimbal mount includes a pitch control arm configured to rotate the engine along the pitch axis.

12. The aerial vehicle platform of claim 11, wherein the pitch control arm is movable on a horizontal plane to control rotation of the engine along the yaw axis.
